(19) United States
(12) Patent Application Publication
(10) Pub. No.: US 2023/0114256 A1
(43) Pub. Date: Apr. 13, 2023

(54) FEATURE MODIFICATION IN STANDBY MODE BASED ON POWER SOURCE CAPACITY

(71) Applicant: HEWLETT-PACKARD DEVELOPMENT COMPANY, L.P., SPRING, TX (US)

(72) Inventors: YI-FAN HSIA, TAIPEI CITY (TW); CHUN-YEN HU, TAIPEI CITY (TW); PO CHIN CHUNG, TAIPEI CITY (TW); HUNG LUNG CHEN, TAIPEI CITY (TW)

(21) Appl. No.: 17/905,354

(22) PCT Filed: Mar. 19, 2020
(86) PCT No.: PCT/US20/23542

§ 371 Date: Aug. 31, 2022

(51) Int. Cl. G06F 1/3287

(52) U.S. Cl. CPC G06F 1/3287

(57) ABSTRACT

Examples of computing devices for modifying a feature in a standby mode based on power source capacity are described herein. In an example, a computing device may include a power source and a controller. While the computing device is in a standby mode and is being powered by the power source, the controller may monitor a remaining capacity of the power source. Upon determining that the capacity of the power source is below a threshold, the controller may modify a setting of a feature of the computing device.

### BACKGROUND

Computing devices, such as personal computers, laptops, notebooks, etc., transition to a standby mode when a computing device is idle for some time.

### BRIEF DESCRIPTION OF FIGURES

The detailed description is provided with reference to the accompanying figures, wherein:

FIG. 1 illustrates a computing device for modifying a feature in a standby mode based on power source capacity, according to an example;

FIG. 2 illustrates a computing device for modifying a feature in a standby mode based on power source capacity, according to an example;

FIG. 3 illustrates a computing device for modifying a feature in a standby mode based on power source capacity, according to an example;

FIG. 4 illustrates a call flow diagram for modifying a feature in a standby mode based on power source capacity, according to an example; and

FIG. 5 illustrates a non-transitory computer readable medium for modifying a feature in a standby mode based on power source capacity, according to an example.

### DETAILED DESCRIPTION

A computing device, such as a laptop computer, a tablet, etc., may include various features, such as video output feature, processor operation, an operating system update feature, a wireless communication feature, a wake-up feature, a hibernation mode feature, and so on. These features may provide various functionalities for normal operation of the computing device in a normal working mode or in a low power mode. In the normal working mode, an operating system of the computing device may operate normally with all drivers and services loaded. Such features when enabled in the computing device, may draw power from a power source, such as an in-built battery, of the computing device.

When the computing device is idle or inactive for an extended period of time, the computing device may switch from a normal working mode to a standby mode. In the standby mode, the computing device may enter a very-low power idle state while allowing certain background activity. For example, in the standby mode, certain features of the computing device may remain enabled. As the standby mode may consume less power than the normal working mode, the features that are enabled in the standby mode may remain unmonitored and uncontrolled. When the computing device remains in the standby mode for a long period of time, such as overnight, even these features may consume power. This may result in reduction of a battery capacity of the computing device in the standby mode. Therefore, an efficiency of the computing device may be reduced.

The present subject matter discloses example approaches for modifying a feature in a standby mode of a computing device based on capacity of a power source of the computing device. This may facilitate in reducing the power consumption of the computing device in the standby mode. For example, a feature which is enabled in the standby mode may be disabled, based on a remaining capacity of the power source, to reduce the power consumed by the feature.

The present subject matter describes example computing devices for modifying a feature from a set of features, when the computing device is in the standby mode. For example, in the standby mode of the computing device, a controller of the computing device may determine that the computing device is being powered by a power source, such as an in-built battery. Based on the determination, a remaining capacity of the power source may be monitored. For example, the remaining capacity of the power source may be monitored at a regular time interval.

Based on the monitoring, when it is determined that the remaining capacity of the power source may fall below a threshold, the controller may modify a setting of the feature of the computing device, to reduce the power consumption of the computing device in the standby mode. For example, if the remaining capacity of the power source may fall below a threshold of 50%, the controller may disable a wireless communication feature of the computing device.

Accordingly, the present subject matter facilitates in enhancing life of the power source of the computing device in a standby mode. Further, as the controller may modify the settings of the features based on the remaining capacity of the power source, the present subject matter may reduce the power consumption of the computing device in the standby mode, without employing additional hardware resources.

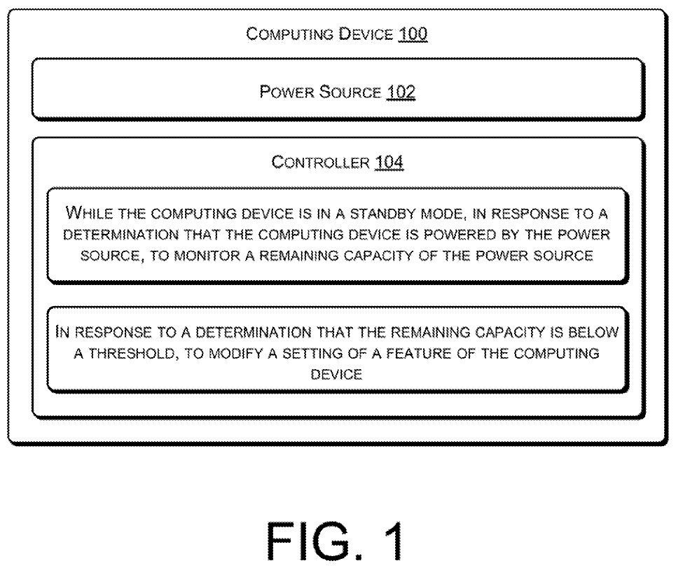

FIG. 1 illustrates a computing device 100 for modifying a feature in a standby mode based on power source capacity, according to an example. In the standby mode, the computing device may enter a very-low power idle state while allowing certain background activity. Examples of the computing device 100 may include, but are not limited to, a laptop, a notebook computer, and a tablet. The computing device 100 may include a power source 102, such as a battery; that may be capable of powering the computing device 100. Examples of the power source 102 may include, but are not limited to, a Nickel-Cadmium battery, Nickel Metal Hydride, or a Lithium Ion battery. In an example, the power source 102 may be a single battery or multiple batteries.

The computing device 100 may also include a controller 104 that may be coupled to the power source 102 of the computing device 100. The controller 104 may be a microcontroller that may handle various tasks of the computing device 100 which are not handled by an operating system of the computing device 100. In an example, the controller 104 may determine that the computing device 100 is being powered by the power source 102. In response to the determination that the computing device 100 is being powered by the power source 102, the controller 104 may monitor a remaining capacity of the power source 102. For example, the embedded controller 104 may monitor remaining battery capacity of the computing device 100, when the computing device 100 is in the standby mode. The remaining battery capacity of the computing device 100 may be determined at a regular time interval.

If the controller 104 determines that the remaining capacity of the power source 102 is below a threshold, the controller 104 may modify a setting of a feature of the computing device 100. The threshold may be a level of capacity of the power source 102 at which each feature is to be disabled, thereby altering the power consumption of the computing device 100. For example, if the controller 104 may determine that the remaining capacity of the power source 102 may have gone below a threshold of 70%, the controller 104 may modify the setting corresponding to the feature. In an example, the modification of the settings for each feature may be pre-defined. Based on the pre-defined modifications, the controller 104 may perform the actions to optimize the consumption of the power source 102 when the computing device 100 is in the standby mode.

The computing device 100 thus facilitates in efficiently managing the power that may be drawn, from the power source 102, when the computing device 100 is in the standby mode. Although the modification of the feature in the standby mode based on power source capacity is explained with respect to the controller 104, the feature may be modified in the standby mode based on the power source capacity by any other controller or microprocessor of the computing device 100, which is separate from a processor (not shown) of the computing device 100.

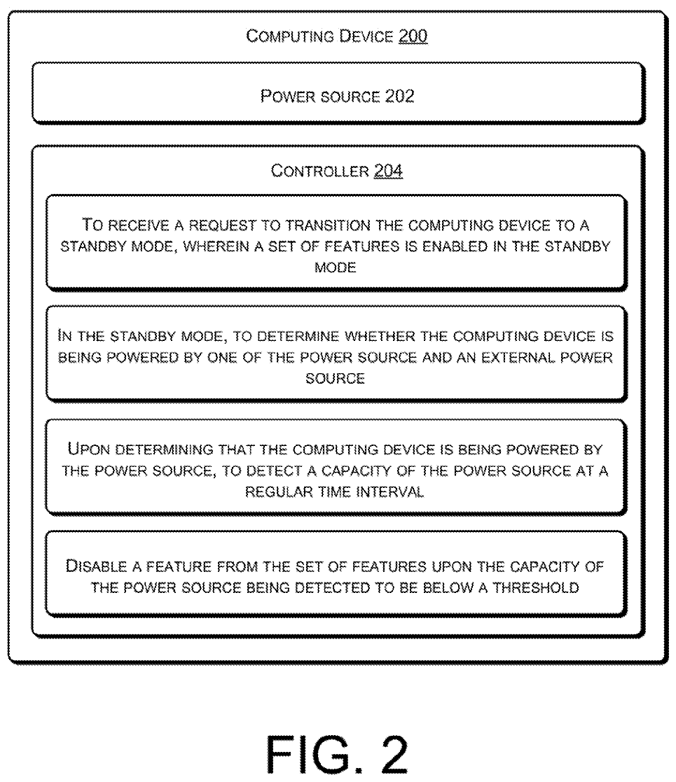

FIG. 2 illustrates a computing device 200 for modifying a feature in a standby mode based on power source capacity, according to an example. In an example, the computing device 200 may be similar to the computing device 100. The computing device 200 may include a power source 202. The power source 102 may be similar to the power source 102. Further, the computing device 200 may include a controller 204 that may be coupled to the power source 202 of the computing device 200. The controller 204 may be similar to the controller 104.

In an example, when the computing device 200 is being used in the normal working mode, such as the S0 mode, different features supported by the computing device 200 may be active. For example, the different features of the computing device 200 that may be active in the normal working mode may include, but are not limited to, an operating system update feature, a wireless communication feature, a wake-up on voice feature, a wake-up on external device feature, a hibernation mode feature, a navigation feature, proximity sensor feature, ambient light sensor feature, cloud synchronization feature, video graphics array (VGA) port feature, high definition multimedia interface (HDMI) port feature, and local area network (LAN) port feature. As long as the computing device 200 is in the normal working mode, the different features of the computing device 200 may remain enabled or active, irrespective of how the computing device 200 is being powered. For example, if the computing device 200 is being powered by the power source 202 or by an external power source, the different features may remain enabled.

When the computing device 200 is to transition from the normal working mode to the standby mode, a request may be received by the controller 204. In the standby mode, the computing device 200 may enter a very-low power idle (Modern standby) state while a set of features may remain enabled. The set of features may be pre-defined. For example, the set of features may include the operating system update feature, the wireless communication feature, the wake-up on voice feature, the wake-up on external device feature, and the hibernation mode feature.

Upon being transitioned to the standby mode, the controller 204 may determine whether the computing device 200 is being powered by the power source 202 or the external power source (not shown). In an example, the external power source may be an external battery or an alternating current (AC) power supply. In an example, the controller 204 may communicate with a port of the computing device 200 to which the external power source may be connected. In another example, the controller 204 may communicate with the power source 202 to determine if the external power source is connected to the computing device 200.

When the controller 204 may determine that the computing device 200 is being powered by the power source 202, while in the standby mode, the controller 204 may detect a capacity of the power source 202. The capacity of the power source 202 may be a remaining charge of the power source 202, when the computing device 200 is in the standby mode. In an example, the controller 204 may communicate with the power source 202 to detect the capacity of the power source 202 at regular time intervals. For example, the controller 204 may monitor a remaining capacity of the power source 202 of the computing device 200 at a time interval of about 15 minutes. In an example, instead of checking the capacity of the power source 202, the controller 204 may receive a notification from the power source 202 indicating about a current capacity of the power source 202.

When the capacity of the power source 202 is detected to be below a threshold, the controller 204 may disable a feature from the set of features of the computing device 200. In an example, threshold may be defined for different ranges of capacity of the power source 202, to disable certain features at those ranges of the capacity of the power source 202. For example, the controller 204 may determine that the capacity of the power source 202 may have gone below a threshold of 70% and is in a range of about 69% to about 40%, the controller 204 may disable any operating system update feature that may be taking place or pending in the computing device 200 and a wireless communication feature. The disabling of the features, when the capacity of the power source 202 is below the threshold, may facilitate in reducing power consumption when the computing device 200 is in the standby mode.

Although the present subject matter is explained with reference to the set of features, the features may include any function or operation under the control of the controller 204 that affects the power drawn from the power source 202 of the computing device 200. Thus, features are not limited to those mentioned with reference to FIG. 2 and may include a clock speed of the controller 204, a frequency of any operation, etc.

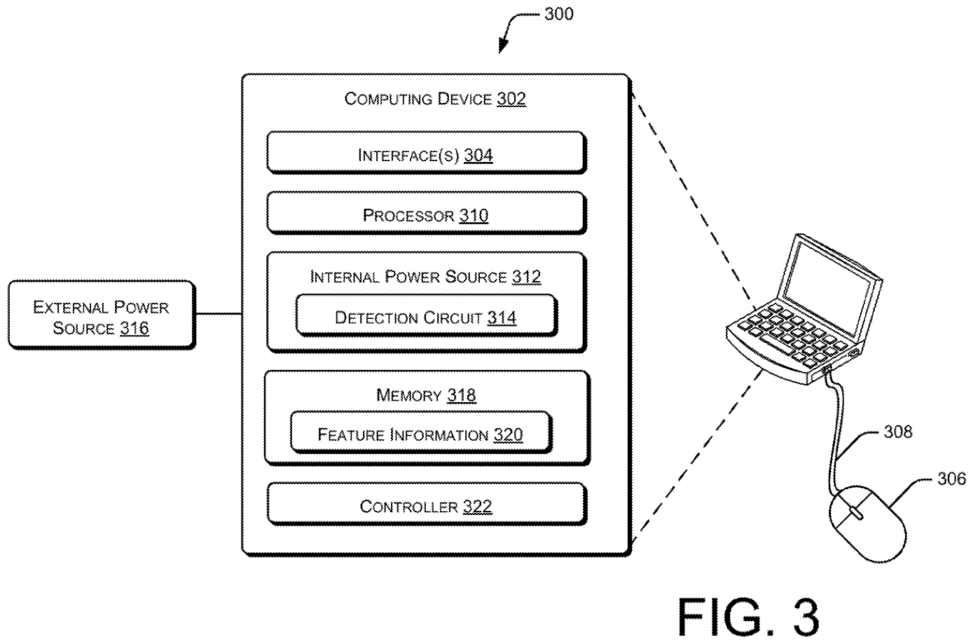

FIG. 3 illustrates a system environment 300 for modifying a feature in a standby mode based on power source capacity, according to an example. The system environment 300 may include a computing device 302, similar to the computing device 100 and 200. Examples of the computing device 302 may include, but are not limited to, a laptop computer, a notebook computer, and a tablet.

In an example, the computing device 302 may include interface(s) 304. The interface(s) 304 may include a variety of interfaces, for example, interface(s) 304 for external devices 306. In an example, the interface(s) 304 may include a Universal Serial Bus (USB) interface that may be used to connect external devices 306 to the computing device 302. The interface(s) 304 may include data output devices. The interface(s) 304 may facilitate the communication of the computing device 302 with various communication and electronic devices. In an example, the external devices 306 may be coupled to the computing device 302 through a USB cable 308.

Further, the computing device 302 may include a processor 310. The processor 310 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

Any requests for transitioning to the standby mode may be received by the processor 310. The request for transition to the standby mode is received from the processor 310 based on one of a user input and an occurrence of an event. For example, while working on the computing device 302, the user may provide an input to transition to the standby mode. The user may either press a key on a keyboard or select a pre-defined icon through the interface(s) 304. In an example, upon occurrence of an event, such as on detecting inactivity on the computing device 302 for about 10 minutes, the processor 310 may automatically make the transition to the standby mode. When the computing device 302 transitions or enters the standby mode, the processor 310 may become inactive.

In one example, the computing device 302 includes an internal power source 312, such as a battery, that may be capable of powering the computing device 302. Examples of the battery may include, but are not limited to, a Nickel-Cadmium battery, Nickel Metal Hydride, or a Lithium Ion battery. In an example, the battery may be a single battery or multiple batteries. The internal power source 312 may be similar to the power source 102 and 202. Further, the internal power source 312 may include a detection circuit 314. The detection circuit 314 may be a battery management system that may receive a threshold for different capacities of the internal power source 312, store the threshold(s), and monitor a current capacity of the internal power source 312. In an example, the threshold may be preset based on a current capacity of the internal power source 312. In an example, the threshold may be set by the user or a manufacturer of the computing device 302. The detection circuit 314 may also detect if the computing device 302 is being powered by the internal power source 312 or by an external power source 316. The external power source 316 may be an external battery or an alternating current (AC) power supply.

Further, the computing device 302 may include a memory 318. The memory 318 may include any non-transitory computer-readable medium including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

In an example, the processor 310 may communicate with the internal power source 312 to obtain information pertaining to each feature that is enabled with respect to a capacity of the internal power source 312. In an example, the detection circuit 314 may indicate the features for different power levels of the internal power source 312 that are to be modified. The features and corresponding thresholds for different capacities of the internal power source 312 may be stored in the memory 318 as feature information 320. The feature information 320 may be changed by the user. Table 1 below provides exemplary ranges of the capacities of the internal power source 312 and the corresponding features that are to be modified, when the computing device 302 is in the standby mode.

TABLE 1

| Capacity | Operating | Wireless | | Wake | Wake |
|---|---|---|---|---|---|
| of Power | System | Commu- | | On | from |
| Source | Update | nication | Hibernate | Voice | USB |
| 100%~70% | Disabled | Enabled | 48 hours | Enabled | Enabled |
| 69%~40% | Disabled | Disabled | 32 hours | Enabled | Enabled |
| 39%~20% | Disabled | Disabled | 16 hours | Disabled | Enabled |
| 19%~0% | Disabled | Disabled | 4 hours | Disabled | Disabled |

Further, the computing device 302 may also include a controller 322. The controller 322 may be a microprocessor of the computing device 302, which is separate from the processor 310. The controller 322 may manage the features which draw power from the internal power source 312, when the computing device 302 is in standby mode. In an example, in standby mode of the computing device 302, the controller 322 may determine a charge stored in the battery at a regular time interval. For example, the controller 322 may communicate with the internal power source 312 to determine a capacity of the internal power source 312 at a first time instance (T1) and a second time instance (T2), such that the T1 and T2 are separated by 15 minutes. In an example, the detection circuit 314 of the internal power source 312 may share information pertaining to the charge stored in the internal power source 312 with the controller 322, upon being requested by the controller 322. In another example, the internal power source 312 may voluntarily share the information pertaining to the charge stored in the internal power source 312 with the controller 322.

If the determined charge stored in the power source 312 goes below a threshold, the controller 322 may retrieve the feature information 320 from the memory 318 of the computing device 302. For example, when the controller 322 may determine that the capacity of the power source 312 is within a range of about 100% to about 70%, the controller 322 may disable the operating system update feature of the computing device 302. In addition, the controller 322 may change a setting of the hibernation mode feature to 48 hours, Subsequently, if the controller 322 may determine that the capacity of the power source 312 has gone below the threshold of 70% and is within a range of about 69% to about 40%, the controller 322 may disable the wireless communication feature of the computing device 302. In addition, the controller 322 may change a setting of the hibernation mode feature to 32 hours.

Upon further depletion of the capacity of the internal power source 312, the controller 322 may determine that the capacity of the internal power source 312 may have fallen below the threshold of 40% and is within a range of about 39% to about 20%, the controller 322 may disable the wake on voice feature of the computing device 302. In addition, the controller 322 may change a setting of the hibernation mode feature to 16 hours. Furthermore, when the controller 322 may determine that the capacity of the internal power source 312 has gone below the threshold of 20% and is within a range of about 19% to about 0%, the controller 322 may disable the wake on Universal Serial Bus (USB) feature of the computing device 302. For example, within the range of about 19% to about 0% of the capacity of the internal power source 312, the controller 322 may communicate with a USB port of the computing device 302, to disable the external device 306 that may be connected to the computing device 302. In addition, the controller 322 may change a setting of the hibernation mode feature to 4 hours.

In an example implementation, if the determined capacity of the internal power source 312 may not go below the threshold for a specified range of the capacity of the internal power source 312, the controller 322 may continue to monitor the remaining capacity of the internal power source 312 at the fixed time interval.

In another example implementation, when the computing device 302 is in the standby mode, the controller 322 may periodically ascertain that the computing device 302 is being powered by the external power source 316. For example, the controller 322 may communicate with the port of computing device 302 that may receive external power source 316. In another example, the detection circuit 314 may communicate with the controller 322 to notify that the computing device 302 is being powered by the external power source 316. Upon ascertaining that the computing device 302 is being powered by the external power source 316 while in the standby mode, the controller 322 may enable the set of features that were disabled based on the capacity of the internal power source 312.

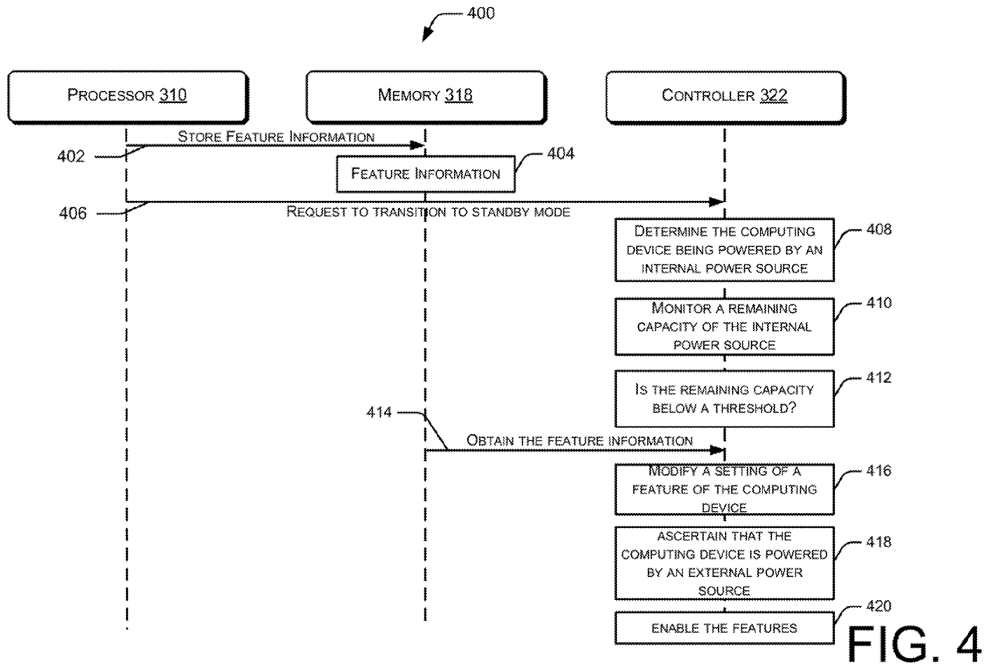

FIG. 4 illustrates a call flow diagram 400 for modifying a feature in a standby mode based on power source capacity, according to an example of the present subject matter. The various arrow indicators used in the call flow diagram 400 depicts the transfer of data between the various entities in the system environment 300, and between the computing device 302 and the external power source 316. The order in which the call flow diagram 400 is described is not intended to be construed as a limitation, and any number of the described steps may be combined in any order to implement the call flow diagram 400, or an alternative method. Further, certain trivial steps have been omitted in the sequence diagrams, for the sake of brevity and clarity.

Referring to FIG. 4, at step 402, the processor 310 may store feature information in the memory 318 of the computing device 302. In an example, the feature information may include various features and corresponding thresholds for different capacities of the internal power source 312. The feature information may therefore indicate at what capacity of the internal power source 312, which features may remain enabled or unmodified. The feature information may get stored in the memory 318, as depicted at step 404.

At step 406, the controller 322 may receive a request to transition into the standby mode. For example, the controller 322 may receive the request for transition to the standby mode is received from the processor 310 based on one of a user input and an occurrence of an event.

At step 408, the controller 322 may determine whether the computing device 302 is being powered by an internal power source 312 or an external power source 316. In an example, the internal power source 312 may be an in-built battery and the external power source 316 may be an AC power source.

At step 410, when the controller 322 may determine that the computing device 302 is being powered by the internal power source 312 while being in the standby mode, the controller 322 may monitor a remaining capacity of the internal power source 312. In an example, the controller 322 may monitor the remaining capacity of the internal power source 312 at a regular time interval, such as after every 15 minutes.

Further, at step 412, the controller 322 may check if the remaining capacity of the internal power source 312 is below a threshold. If the remaining capacity has fallen below the threshold, the controller 322 may retrieve the feature information from the memory 318, as shown in step 414. On the other hand, if the remaining capacity of the internal power source 312 has not fallen below the threshold, the controller 322 may continue to monitor the remaining capacity at the regular time interval.

At step 416, the controller 322 may modify the setting of a feature of the computing device 302. For example, the controller 322 may disable the feature when the remaining capacity of the internal power source 312 goes below a threshold. In another example, the controller 322 may change a setting of the feature, such as the hibernation feature, when the remaining capacity goes below the threshold.

Further, at step 418, the controller 322 may ascertain that the computing device 302 is being powered by the external power source 316. For example, the controller 322 may communicate with the port of computing device 302 that may receive external power source 316. In another example, the detection circuit 314 may communicate with the controller 322 to notify that the computing device 302 is being powered by the external power source 316.

Further, at step 420, the controller 322 may upon ascertaining that the computing device 302 is being powered by the external power source 316 while in the standby mode, enable the set of features that were disabled based on the capacity of the internal power source 312.

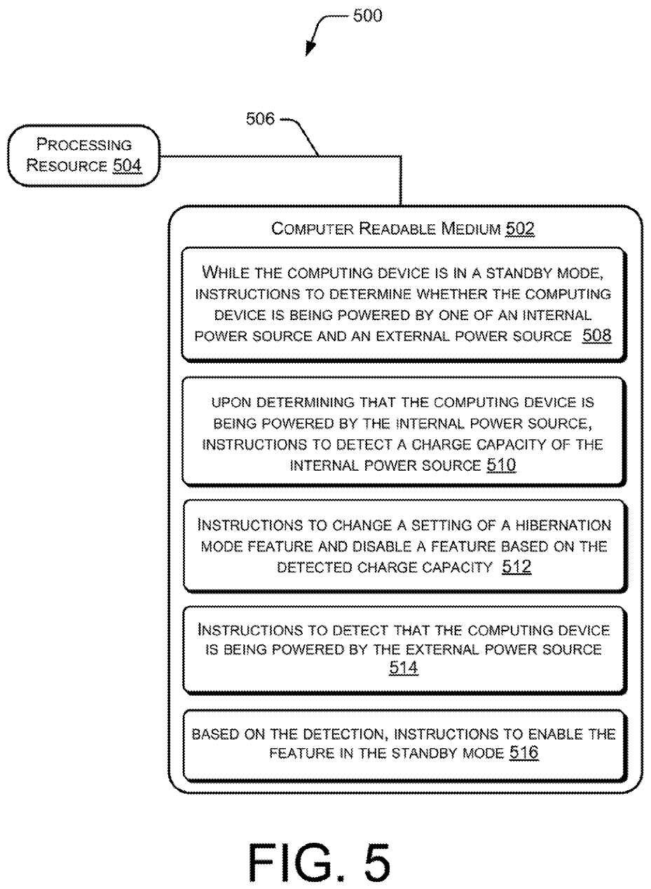

FIG. 5 illustrates an example system environment 500 using a non-transitory computer-readable medium 502 for modifying a feature in a standby mode based on power source capacity, according to an example. The system environment 500 includes a processing resource 504 communicatively coupled to the non-transitory computer-readable medium 502 through a communication link 506, For example, the processing resource 504 may be a processor or a controller of a computing system, such as the computing device, for fetching and executing computer-readable instructions from the non-transitory computer-readable medium 502.

The non-transitory computer-readable medium 502 may be, for example, an internal memory device or an external memory device. In one example, the communication link 506 may be a direct communication link, such as one formed through a memory read/write interface. In another example, the communication link 506 may be an indirect communication link, such as one formed through a network interface. In such a case, the processing resource 504 may access the non-transitory computer-readable medium 502 through a network (not shown).

In an example, the non-transitory computer-readable medium 502 includes a set of computer-readable and executable instructions for modifying a feature in a standby mode based on power source capacity. The set of computer-readable instructions may include instructions as explained in conjunction with FIGS. 1 to 3. The set of computer-readable instructions, referred to as instructions hereinafter, may be accessed by the processing resource 504 through the communication link 506 and subsequently executed to perform acts for modifying a feature in a standby mode based on power source capacity.

Referring to FIG. 5, in an example, the non-transitory computer-readable medium may include instructions 508 to determine whether the computing device is being powered by one of an internal power source and an external power source, while the computing device is in the standby mode. In the standby mode, the computing device may enter a very-low power idle state while allowing certain background activity. In an example, a controller of the computing device may determine whether the computing device is being powered by the internal power source and the external power source. In an example, the internal power source is a direct current (DC) power source, such as a battery of the computing device and the external power source is an alternating current (AC) power source.

The non-transitory computer-readable medium 502 may also include instructions 510 to detect a charge capacity of the internal power source upon determining that the computing device is being powered by the internal power source. The charge capacity of the internal power source may be a remaining capacity of the internal power source when the computing device is in the standby mode.

The non-transitory computer-readable medium 502 may include instructions 512 to change a setting of a hibernation mode feature and disable a feature based on the detected charge capacity of the internal power source. In an example, if the charge of the battery may be within a range of about 100% to about 70%, the controller may change the setting of the hibernation mode feature such that the computing device may switch to the hibernation mode in 48 hours. In addition, the controller may disable any operating system update in the computing device. In another example, if the charge of the battery may be within a range of about 69% to about 40%, the controller may change the setting of the hibernation mode feature such that the computing device may switch to the hibernation mode 32 hours. In addition, the controller may disable any wireless network connections in the computing device.

The non-transitory computer-readable medium 502 may include instructions 514 to detect that the computing device is being powered by the external power source. For example, the controller may determine that the computing device is being connected to the external power source, such as an AC power source for powering the computing device and the battery of the computing device is not being consumed.

In addition, the non-transitory computer-readable medium 502 may include instructions 516 to enable the feature in the standby mode, based on the detection. Thus, as soon as the controller may detect that the computing device is being powered by the AC power source, the controller may enable the features that have been disabled so far. In addition, the controller may change the setting of the hibernation mode feature such that the computing device may not able be to switch to the hibernation mode as long as the computing device is being powered by the AC power source.

Although aspects for the present disclosure have been described in a language specific to structural features and/or methods, it is to be understood that the appended claims are not limited to the specific features or methods described herein. Rather, the specific features and methods are disclosed as examples of the present disclosure.

We claim:

1. A computing device comprising:
a power source;
a controller coupled to the power source, the controller is to,
while the computing device is in a standby mode, in response to a determination that the computing device is powered by the power source, monitor a remaining capacity of the power source; and
in response to a determination that the remaining capacity is below a threshold, modify a setting of a feature of the computing device.

2. The computing device as claimed in claim 1, wherein to modify the setting of the feature, the controller is to disable the feature.

3. The computing device as claimed in claim 1, wherein to modify the setting of the feature, the controller is to change a setting of the feature.

4. The computing device as claimed in claim 2, wherein while the computing device is in the standby mode, in response to a detection that the computing device is powered by an external power source, the controller is to enable the feature.

5. The computing device as claimed in claim 4, wherein the external power source comprises an alternating current (AC) power source.

6. The computing device as claimed in claim 1, wherein the feature comprises an operating system update feature, a wireless communication feature, a wake-up on voice feature, a wake-up on external device feature, and a hibernation mode feature.

7. A computing device comprising:
a power source; and
a controller coupled to the power source, the controller is to,
receive a request to transition the computing device to a standby mode, wherein a set of features is enabled in the standby mode;
in the standby mode, determine whether the computing device is being powered by one of the power source and an external power source;
upon determining that the computing device is being powered by the power source, detect a capacity of the power source at a regular time interval; and
disable a feature from the set of features upon the capacity of the power source being detected to be below a threshold.

8. The computing device as claimed in claim 7, wherein the computing device comprises a memory to store information pertaining to each feature that is enabled with respect to a capacity of the power source.

9. The computing device as claimed in claim 7, wherein the threshold is preset based on a current capacity of the power source.

10. The computing device as claimed in claim 7, wherein the controller is to periodically ascertain that the computing device is being powered by an external power source.

11. The computing device as claimed in claim 10, wherein, upon ascertaining that the computing device is powered by the external power source while the computing device is in the standby mode, the controller is to enable the set of features.

12. The computing device as claimed in claim 7, wherein the request for transition to the standby mode is received based on one of a user input and an occurrence of an event.

13. A non-transitory computer-readable medium comprising computer-readable instructions, which, when executed by a processing resource of a computing device, cause the processing resource to:
while the computing device is in a standby mode, determine whether the computing device is being powered by one of an internal power source and an external power source;
upon determining that the computing device is being powered by the internal power source, detect a charge capacity of the internal power source;
change a setting of a hibernation mode feature and disable a feature based on the detected charge capacity;
detect that the computing device is being powered by the external power source; and
based on the detection, enable the feature in the standby mode.

14. The non-transitory computer-readable medium as claimed in claim 13, wherein the feature comprises an operating system update feature, a wireless communication feature, a wake-up on voice feature, a wake-up on external device feature, and a hibernation mode feature.

15. The non-transitory computer-readable medium as claimed in claim 13, wherein, the internal power source is a direct current (DC) power source and the external power source is an alternating current (AC) power source.
